(19) United States
(12) Patent Application Publication
(10) Pub. No.: US 2007/0100955 A1
(43) Pub. Date: May 3, 2007

(54) System and method for using known geographic locations of Internet users to present local content to web pages

(76) Inventor: Oran Joseph Bodner, Zichron Yaakov (IL)

Correspondence Address: ORAN JOSEPH BODNER, 2 HITTA ST., ZICHRON YAAKOV, 30900, IL

(21) Appl. No.: 11/163,767

(22) Filed: Oct. 29, 2005

(51) Int. Cl. G06F 15/16

(52) U.S. Cl. 709/217

(57) ABSTRACT

This invention enables viewing local content over the Internet. By putting the smarts in a hub/node near the Internet user, where the geographic location of the user is known, a mechanism on said hub can either provide this location to requested web sites, or present the local information to the user itself, by substituting web-page sub-sections with local content. Furthermore, this hub can be a web server itself, for servicing local requests from the users.

When a user sends a request to view a page on the Internet, the geographic location of the user may be derived automatically from the request. As the request proceeds from the user to the requested Internet server, each hub/node on the route knows which hub/node preceded it (if only to know where to return the requested information to). In particular, the first hub after the user knows who and where the end user is, and the service provider also knows who the user is (if only for billing purposes).

Using this information, such a hub may provide local content to the user, either by direct request from the user, or by supplanting local content in Internet pages, in areas reserved for such purpose. Alternatively, Internet pages themselves can use the locality of the user, either by tracing the request or getting that information from “upstream” nodes (with user consent, of course).

There were previous attempts, of course, to couple web pages with the geographic location of the user, both covert (e.g. cookies, spyware), and overt (e.g. online registration forms, links to geographic-specific pages). Using another method, examining the IP address of the user, the country of origin may be inferred, which is not very useful. U.S. Pat. No. 6,629,136 to Naidoo, 1999 proposed to use the user-registration information on the network/Internet server, while U.S. Pat. No. 6,757,740 to Parekh et al., 2000) proposes back-tracing the user request to its source. Both of the above patents suggest some central database for storing the user-locations or local content, with elaborate look-up and authentication required to use this information. This is counter to the Internet, where users and web sites are distributed, by definition.

Accordingly, several objects and advantages of this invention are:
(a) It uses readily available knowledge, requires no registration, no prior knowledge, no authentication, no fancy tracing mechanisms, and is advantageous to all parties involved.
(b) It can provide local content with or without expressed user consent.
(c) Its function relies only on the location of the Internet user, and doesn't even need to know who the user is who is making the request.
(d) It introduces the concept of substitutable web-page templates, where sub-sections of a web page may be substituted for local content.

With the smarts in the hub (in the Internet Service Provider (ISP), for example), the web site does not need to know the location of the user. It may just reserve sub sections of its web page for local content, to be filled in by the hub as the page is returned from the web site server to the user. As the hub may intercept the Internet traffic, both on the way out (the request) and on the way back in (the requested web page), it may do more than just pass the information along to its next destination. In fact, it already does more that reroute/retransmit the information: Firewalls are common nowadays, that can filter both outgoing and incoming Internet traffic. Such filters usually either permit or forbid the information to go through.

What is proposed here is the next step: Change the information (coming back from the web), by substituting some sections of the web page, some “filler” which is put there by the web site in the intent that it be replaced, with local content, also by consent of the web site.

The user need not know about this replacement, or not care, as he/she expects to see some advertisements or other content, never knowing which ads or other content may pop up. And the user's location or other private information is not compromised, as it never leaves the hub.

Under this scenario, the user requests, say, CNN.com. The hub (say, the ISP) receives the request, goes out to the Internet and retrieves that page, and then scans the page for these said html element indicators for section replacement, which may look something like the following:
<localreplace=“Local 1” src=http://www.cnn.con/localnews/>
This is general news, hopefully replaced by local news.
</localreplace>
   The ISP knows where the request came from, for example (using the zip code notation) area 90210. In can then check if the replacement link exists for that area, e.g. http://www.cnn.con/localnews/90210
If so, ISP then performs a minor surgical procedure:
It edits the page, substituting the section enclosed by the <localreplace> element with that in the link, and proceeds on to the next modifiable sections, thus inserting local news, local weather, local ads, etc. in place of those sections indicated.

There may be several variations to the above scenario:
(a) Instead of a link back to the web site, we can have:
   <localreplace=“Local 1” (place local ad #1 here)>
      And then the ISP, which stores its own cache of local ads, news, etc. picks an ad and inserts it in its place,
(b) If user-consent is requested and obtained, the user-location may be given to web sites, by adding the location to the user requests on the way out to the web, passed as a parameter to the requested web site along with the request, and then the web site does as it pleases with this information. In this scenario, for example, a web site (say Pizza.com) can automatically redirect a request to a local web page, based on the user location, obtained either by the above parameter or by the below-described API
(c) The hub provides a set of APIs to incoming web pages, where the web pages may obtain the user location (also requiring consent of the user). In this scenario, an advertiser may rent advertising space on, say, CNN.com, for say, $1000 per square inch, and then sub-let that space to local businesses for a fraction of the cost, making a profit by sub-letting the same space to multiple businesses in different locations. The advertiser will accomplish this by using the above APIs to determine the location of the user requesting to view CNN.com (and hence his ad), and then putting into his ad some html code to display the local ad instead of his.

Lastly, the hub can be a web-server in itself, responding to user requests aimed for local information. This can be done in several ways:
(a) An agreed-upon name, say http://local/ will be intercepted and acted upon by the hub, providing a standard “local” web page, with time, weather, traffic conditions, emergency services, restaurants, skiing, museums, paid local ads, etc. We can even add a new button to the browser, denoting your “home town” to this end. This would be especially handy for tourists or traveling businessmen, who come into a new town and need to get oriented quickly.
(b) A new protocol may be introduced, say: LocalHttp://pizza/, which will be intercepted and serviced by the hub, and not passed along to the Internet.

This invention solves the problem of bringing local content to Internet users in a seamless manner, without requiring user-registration or authentication, yet preserving the privacy of the user. It works dynamically, marking the location of the source of the request (not the user), and requires no central database or other such mechanism on the Internet. The concept of replacing sub-sections of a web page before returning it to the user is new, and allows the substitution of general content with local content.

In this manner one can also access local information (weather, emergency, local eateries and entertainment, local announcements) without relying on cookies or following several links to get there.

It is especially suited for local advertising: Instead of spending thousands of dollars for advertising national/multi-national products on the national level, one can spend a fraction of that for local advertising to the local community: Al's Deli, Mom & Pop's grocery, a local garage, and a local bus or taxi service.

The result is more advertisement, which results in more profits the web sites and ISPs, which may result in lower fees for the Internet users.

What is claimed is:

1. A method of providing local content to a user on the Internet, comprising the steps by hub of
storing local content on the hub
determining location of the user via the source of the request
providing local content to said user corresponding to above user location per user request.

2. The method of claim 1, wherein said hub is comprised of hardware or software, or a combination thereof.

3. The method of claim 1, wherein said hub is a firewall.

4. The method of claim 1, wherein said hub is an Internet Service Provider (ISP).

5. The method of claim 1, wherein said hub is a cable/ADSL provider.

6. The method of claim 1, wherein said hub is a router.

7. The method of claim 1, wherein said hub is a network hub.

8. The method of claim 1, wherein said content is advertisement(s).

9. The method of claim 1, wherein said content is emergency procedures/numbers.

10. The method of claim 1, wherein said content is announcements.

11. The method of claim 1, wherein said content is the weather.

12. The method of claim 1, wherein said content is services.

13. The method of claim 1, wherein said Internet-site template is a web page.

14. The method of claim 1, wherein said Internet-site template is part of a web page.

15. The method of claim 1, wherein said per user request is direct user-request for local content.

16. The method of claim 1, wherein said user request is a mechanism for substituting Internet-site template(s) with location-specific content.

17. The method of claim 1, wherein said per user request is via a mechanism for adding location-specific content.

18. A method of an ISP providing for web pages a set of APIs to determine general location of user-request (e.g. city), for the purpose of the web site delivering local content.
